(19) United States
(12) Patent Application Publication
(10) Pub. No.: US 2005/0198165 A1
(43) Pub. Date: Sep. 8, 2005

(54) Systems and methods for electronic information distribution

(76) Inventors: Frederick A. Reddel V, Greensboro, NC (US); Eric L. Swinson, Jamestown, NC (US)

Correspondence Address: KILPATRICK STOCKTON LLP, 1001 WEST FOURTH STREET, WINSTON-SALEM, NC, 27101, US

(21) Appl. No.: 10/982,015

(22) Filed: Nov. 5, 2004

Related U.S. Application Data
(60) Provisional application No. 60/517,800, filed on Nov. 6, 2003.
(60) Provisional application No. 60/517,801, filed on Nov. 6, 2003.

(51) Int. Cl. G06F 15/16

(52) U.S. Cl. 709/206; 709/217

(57) ABSTRACT

Systems and methods secure electronic information distribution are described. In one described system, a sender creates a package, specifying the attributes, files, and recipients associated with the package. The package is received at a package distribution server, which stores the package and transmits a notification to the recipient of the availability of the package. Subsequently, the recipient issues a request to the package distribution server for the package, and the package distribution server receives the request and transfers the file to the recipient. The package distribution server may track the transfer, cause charges to be accrued against the seller, and perform other functions related to the information transfer.

### RELATED APPLICATION

This application claims priority to provisional U.S. patent application, Ser. No. 60/517,800, filed Nov. 6, 2003, titled, “Secure Electronic Information Transfer and Storage System,” and to provisional U.S. patent application, Ser. No. 60/517,801, filed Nov. 6, 2003, titled, “Secure Electronic Information Transfer Encryption Method,” the entirety of both of which are incorporated herein by reference.

### FIELD OF THE INVENTION

This invention relates generally to electronic information transfer and storage. In particular, this invention relates to transfer of electronic information from sender to recipient through a distribution point.

### BACKGROUND

Distribution of electronic information in the form of electronic documents, files, programs, video files, audio files, and other media from individual to individual, individual to company, and company to company occurs millions of times every day. This distribution takes place in the form of e-mail attachments, File Transfer Protocol (FTP), Peer to Peer, Virtual Private Networks (VPNs), parcel courier and other information delivery mechanisms.

One of the most common methods for individuals to transfer electronic information is through e-mail attachments. While this may work relatively well for small electronic documents, large and other common types of electronic data will not successfully transmit through e-mail. Even if the information can be transferred, the data is exposed at every connecting point in the network between the sender and the receiver and therefore is insecure.

File Transfer Protocol (FTP) requires prior set up and account management in order to operate. To simplify this process, many companies provide a public FTP location for information to be shared. In this case, all information stored in this area is accessible by anyone who finds it. Sometimes an FTP area requires the user to log in with a user name and password, but that only gives the false sense that the information being transferred is secure.

Information being transferred using Peer-to-Peer technology is accomplished by using the connecting computers system resources to serve electronic information to others wanting to access it. The information to be transferred is not published, but rather searched and found by those looking for it. During the time the information is not being transferred, all other information within the connecting computers is at risk. Since the information is located by name, the actual information received could be completely unexpected or even worse, damaging to the receiving party's system.

Virtual Private Networks (VPNs) are established by systems administrators to provide a private transmission path between sender and receiver. This method opens an entry point for someone outside of a network to access it as if they were inside the network. While VPNs may provide secure transfer of information between the two established network points, there is no way to share information outside of this path. In addition, VPNs require a significant technical infrastructure to install, maintain, and support.

Electronic information can also be transferred via a traditional parcel courier service such as United States Postal Service, UPS, FedEx, or other overnight delivery companies. This method may be more secure than some of the electronic delivery mechanisms. However, it is more costly on a per transaction basis and usually slower to complete.

Other information delivery mechanisms may provide a specific need but ignore more global issues like security, compatibility, or accountability. In all cases, these methods are either insecure, limited in use, or require manual intervention to provision and execute. Validation is also a concern as there is no mechanism readily available in these processes for tracking, logging and reporting the entire transaction.

Although the end result of using these methods is often frustrating, cumbersome, and undesirable, the need to distribute electronic information still remains an important and valuable daily means of communication.

### SUMMARY

Embodiments of this invention provide systems and methods that may be used by individuals and businesses for secure electronic information distribution. The terminology “electronic information transfer” and “storage” are used herein in a manner consistent with their accepted usage. In general, “electronic information transfer” refers to the sending and receiving of electronic information, documents, files, programs, and other media, generally referred to as a “package” between and among individuals and businesses. In general, “storage” refers to the holding and staging of electronic information on magnetic, optical, or other media storage devices.

In an aspect the present invention provides systems, methods and computer readable media that facilitate, from a user's perspective, and from the perspective of overall system architecture, the exchange of electronic information, including the electronic information set forth above. In one embodiment the present invention utilizes a system architecture similar to a hub and spoke model utilized by physical package couriers such as United Parcel Service or Federal Express. The hub comprises a package distribution server. The hub communicates electronically, for example, via the internet, with individual client sender devices.

In one embodiment of this invention, a package distribution server receives a package comprising at least one file from a sender, and performs one or more of the following functions: storing the package, notifying a recipient that the package has been stored, receiving a request from the recipient for the package, and/or transmitting the package to the recipient. The recipient may comprise a first recipient and the request a first request, and the package distribution server may further notify a second recipient that the package has been stored, receive a second request from the second recipient for the package, and transmit the second package to the second recipient.

In one embodiment, the electronic transmission of a package is monitored and the partial or complete delivery of the package among and/or between (sending or receiving) a server and a client device is determined. If transmission is interrupted, with a package only partially received or delivered, transmission may resume with delivery of the remaining elements of the package, as opposed to retransmission of the entire package.

In one embodiment, the package distribution center provides accounting capabilities. For example in one embodiment, the package distribution server records a transaction charge to an account associated with the sender.

The package may comprise one or more attributes. For example, in one embodiment, the package comprises a duration value, and the package distribution server deletes the package upon expiration of the duration value. The package may be associated with various other attributes as well.

In another embodiment of this invention, when a sender wishes to send a package, a client sender device, such as a personal computer, cellular phone, or other processor-equipped device receives from the sender a package attribute associated with a package and a file identifier associated with a file, associates the file with the package, and encrypts the file. The sender client device also receives a recipient identifier associated with a recipient, associates the recipient identifier with the package, causes the package and the associated file to be transmitted to a package hub, and causes a package notification to be sent to the recipient. In one embodiment, encrypting the file comprises encrypting the file using a 3DES encryption, encrypting the file a second time using a pass code, and encrypting the file a third time using secure sockets layer (SSL).

In one embodiment, the sender client device receives a package availability value and associates the value with the package. The availability value determines how long the package is available on the hub before it is deleted or otherwise made non-available.

The client sender device may utilize an authentication value to encrypt the files in the package. In one embodiment, the client sender device associates the authentication value with the package. In one such embodiment, the authentication value is a third-party authentication value, such as an Electronic Postmark™ as provided by the Unites States Postal Service.

In one embodiment, the client sender device authenticates a user. For example, in one embodiment, the client sender device receives a smart card identifier, e.g., a number stored in the smart card circuit. The client sender device utilizes the smart card identifier to authenticate the user. For instance, the client sender device may compare a smart card identification number to a smart card identification number stored in a data store, e.g., a hard drive on the sender's personal computer. In another embodiment, the sender client device compares a smart card identification number to a number entered by the sender. The smart card identifier or other data or code available on the smart card may be used to encrypt the data.

In one embodiment of this invention, a recipient client device receives notice that a package is available at a package hub, the package containing at least one file, requests the package from the package hub, and receives the package from the package hub.

The recipient client device may cause the file to be stored on a hard drive or other storage device. The recipient client device may also receive a first checksum from the package hub and calculate a checksum on the at least one file to ensure that the file or files was received completely and that no corruption has occurred.

In another embodiment, a computer-readable medium (such as, for example random access memory or a computer disk) comprises code for carrying out on or more of the methods described above and in detail below.

These example embodiments are mentioned not to limit or define the invention, but to provide examples of embodiments of the invention to aid understanding thereof. Example embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of this invention are better understood when the following Detailed Description is read with reference to the accompanying drawings, wherein:

FIG. 1 is a block diagram of a system according to one embodiment of this invention;

FIG. 2 is a flowchart illustrating a process for creating and transmitting a package according to one embodiment of this invention;

FIG. 3 is a flowchart illustrating a method for receiving and storing a package for distribution in one embodiment of this invention;

FIG. 4 is a flowchart illustrating a method for receiving a package in one embodiment of this invention;

FIG. 5 is a screenshot of the first page of a package creation user interface in one embodiment of this invention;

FIG. 6 is a screenshot of the second page of the package creation user interface shown in FIG. 5;

FIG. 7 is a screenshot of the third page of the package creation user interface shown in FIGS. 5 and 6; and

FIG. 8 is a screenshot of a user interface for managing incoming and outgoing packages in one embodiment of this invention;

FIG. 9 is a screenshot of a user interface for managing receipt of incoming packages in one embodiment of this invention; and

FIG. 10 is a block diagram illustrating the flow of electronic information in one embodiment of the present invention.

### DETAILED DESCRIPTION

Embodiments of this invention provide systems and methods for electronic document information distribution. For example, in one illustrative embodiment, a sender creates a package, specifying the attributes associated with the package, the files to be included in the package, and the recipient(s) to which the package is directed. The package is received at a package distribution server, which stores the package and transmits a notification to the recipient(s) of the availability of the package.

Subsequently, the recipient(s) issues a request to the package distribution server for the package. The package distribution server receives the request and transfers the file to the recipient(s). The package distribution server may track the transfer, cause charges to be accrued against the seller, and perform other functions related to the information transfer. This and other illustrative embodiments are described below. However, the invention is not limited to this embodiment or the other embodiments described herein.

### System Architecture

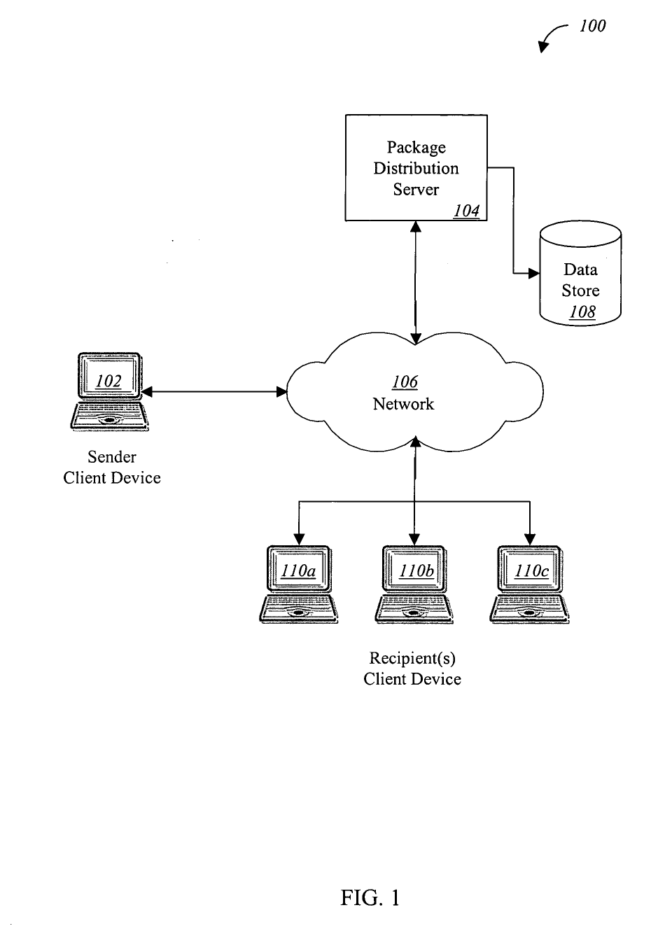

Referring now to the drawings in which like numerals indicate like elements throughout the several figures, FIG. 1 is a block diagram of a system according to one embodiment of this invention. The system 100 shown in FIG. 1 comprises a sender client device 102 in communication with a package distribution server 104 over a network 106. In one embodiment, the network 106 shown comprises the Internet. In other embodiments, other networks, such as an intranet, WAN, LAN, or cellular network may be used.

Through the sender's client device 102, a sender can communicate over the network 106 with other systems and devices coupled to the network 106. As shown in FIG. 1, a package distribution server 104 is also coupled to or in communication with the network 106. The package distribution server 104 shown comprises a server executing a package distribution application program, collectively referred to herein as the package distribution server 104 or electronic information hub. The package distribution server 104 allows senders to create and upload packages for distribution to recipients at recipient client devices 110a-c.

The sender client device 102, package distribution server, and recipient client devices 110a-c shown each comprises a computer-readable medium, such as a random access memory (RAM) in communication with a processor. The processor executes computer-executable program instructions stored in the memory. Such processors may comprise a microprocessor, an ASIC, or state machines. Such processors comprise, or may be in communication with, media, for example computer-readable media, which stores instructions that, when executed by the processor, cause the processor to perform operations, such as those described herein.

Embodiments of computer-readable media include, but are not limited to, electronic, optical, magnetic, or other storage or transmission devices capable of providing a processor, such as the processor of sender's client device 102, with computer-readable instructions. Other examples of suitable media include, but are not limited to, a floppy disk, CD-ROM, DVD, magnetic disk, memory chip, ROM, RAM, an ASIC, a configured processor, optical media, magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The sender's client device 102, package distribution server 104, and recipient client devices 110a-c may also comprise a number of external or internal devices such as a mouse, a CD-ROM, DVD, a keyboard, a display, or other input or output devices. Examples of sender client device 102 and recipient client devices 110a-c are personal computers, personal digital assistants, cellular phones, mobile phones, smart phones, pagers, digital tablets, laptop computers, Internet appliances, and other processor-based devices. In general, the client devices 102, 110a-c may be any type of suitable processor-based platform that is connected to a network 106 and that interacts with one or more application programs. Client devices 102, 110a-c may operate on any operating system, such as Microsoft® Windows® or Linux. The client device 102 shown includes, for example, personal computers executing a browser application program such as Microsoft Corporation's Internet Explorer™, Netscape Communication Corporation's Netscape Navigator™, and Apple Computer, Inc.'s Safari™.

Similar to the client devices 102, 110a-c, the package distribution server 104 shown comprises a processor coupled to a computer-readable memory. The package distribution server 104 is in communication with a data store 108. Package distribution server 104, depicted as a single computer system, may be implemented as a network of computer processors. Examples of a package distribution server 104 are servers, mainframe computers, networked computers, a processor-based device, and similar types of systems and devices. Client processor and the server processor can be any of a number of computer processors, such as processors from Intel Corporation of Santa Clara, California and Motorola Corporation of Schaumburg, Illinois. Although shown as different components in FIG. 1, the package distribution server 104 and data store 108 may be integrated into a single server.

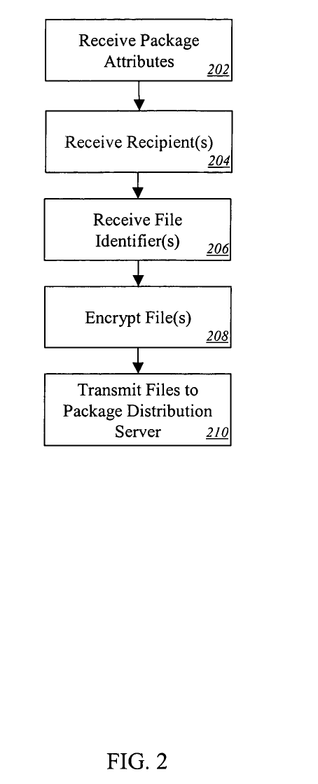

It should be noted that this invention may comprise systems having different architecture than that which is shown in FIG. 1. For example, in some systems according to this invention, package distribution server 104 may comprise a single physical or logical server. The system 100 shown in FIG. 1 is merely an example of a suitable system, and is used to help explain the methods and interfaces illustrated in FIGS. 2-9.

### PACKAGE CREATION

FIG. 2 is a flowchart illustrating a process for creating and transmitting a package according to one embodiment of this invention. To create a package, a sender accesses the sender client device (102) and selects a package creation application program. For example, in one embodiment, the user opens a browser application and enters or selects a uniform resource locator (URL) that points to an application provided by a hypertext transfer protocol (HTTP) server. In response to the request, the HTTP server transmits a hypertext markup language (HTML) page to the sender client device (102). The HTML page includes a pointer to a Java application for package creation, distribution, and tracking (referred to herein as the “sender application”). In some embodiments, the package distribution server 104 may act as the HTTP server.

The sender application may incorporate port sniffing. Port sniffing allows the sender application, and other components of an embodiment of this invention, to operate in the presence of firewalls and corporate or home networks. Port sniffing entails examining each segment of the path from the package distribution server (104) to the sender (102) or recipient client device (110a-c) to determine which ports are available. The application can then utilize the open ports to perform file transfers and other functions.

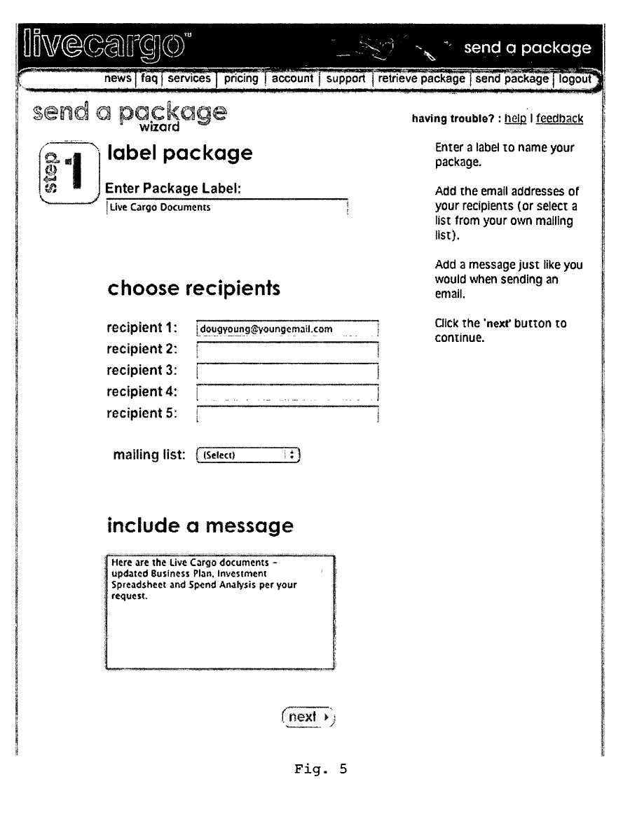

The sender application provides a user interface in which the user can enter attributes of the package, select files for inclusion in the package, select or input recipients for distribution of the package, and perform other activities related to package creation and distribution. A screen shot of one such interface is shown in FIGS. 5-8 and described below. This embodiment of the sender application is merely illustrative. Many other types and styles of interfaces may be utilized by an embodiment of this invention.

In the process shown in FIG. 2, the sender application receives package attributes 202. For example, a user enters a package label and a message. The user may enter additional attributes. For example, in one embodiment, the user may optionally select a passcode for encrypting the files in the package. In another embodiment, the user specifies the lifespan of the package, i.e., the length of time the package will be available on the package distribution server (104).

The sender application also receives one or more recipients 204. The recipients may be received as email addresses or by using some other identifier of a recipient. In one embodiment, the user may select a mailing list to which the package will be available. The mailing list includes one or more recipients grouped together.

The sender application also receives one or more file identifiers 206. For example, the user may click a “Browse” button, triggering display of a representation of the user's hard disk or other available media. The user then selects one or more of the files on the specified media for inclusion in the package. The package sender application may save a fully defined path and file name so that the file can be included in the package when the package is sent.

In the embodiment shown in FIG. 2, when the user has finished specifying the attributes, recipients, and files for a package, the user clicks a “Send Package” button or control. In response, the package sending application encrypts the files to be included in the package 208. Various methods of encryption may be used alone or in conjunction with one another. For example, in one embodiment, a triple Data Encryption Standard (3DES) algorithm is utilized to encrypt the files. In another embodiment, the files are encrypted utilizing a secret word as a key for encrypting/decrypting the file. In such an embodiment, the sender communicates the secret word to the intended recipient(s) of the package via a separate communication channel (e.g., the phone) so that the recipient(s) can successfully decrypt the files in the package. In yet another embodiment, each package is encrypted using a unique key so that each package is uniquely encrypted. In some embodiments, the secret word may be referred to as a pass phrase. Methods of performing encryption utilizing a key are well known to those of skill in the art and will not be described in detail herein.

### Package Distribution Server

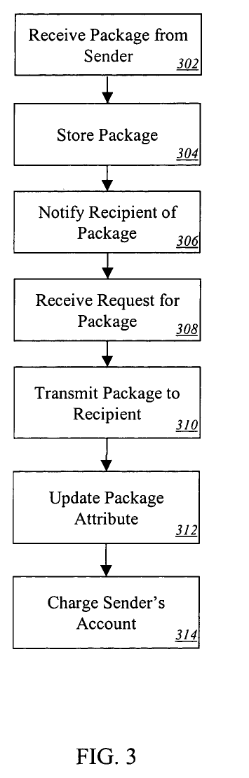

FIG. 3 is a flowchart illustrating a method for receiving and storing a package for distribution in one embodiment of this invention. In the embodiment shown, the package distribution server (104) receives the package, including attributes and files, from a sender client device (102) 302.

Once the package distribution server (104) has received the package, the package distribution server (104) saves the package, including the files, in the data store (108) 304. In other embodiments, the package distribution server (104) may perform calculations to ensure that the entire package was successfully received. For instance, in one embodiment, the package distribution server (104) performs a check sum on each of the files to ensure that what was sent from the sender client device (102) exactly matches what was received on the package distribution center (104).

When the package distribution server (104) receives the package, the package distribution server (104) generates a notification to the intended recipient(s) of the package 306. In one embodiment, the notification is in the form of an email. The text of the email includes instructions for the recipient(s) to access the package distribution server (104) and access the package. The notification may take other forms. For example, in one embodiment, the notification is in the form of a short message system (SMS) message directed to the recipient(s) client device (110a-c), a cellular phone. In another embodiment, the notification is in the form of a page. Various other communications mediums may be utilized by an embodiment of this invention for providing notification.

Subsequent to notifying the intended recipient(s) of the availability of the package, the package distribution server (104) receives a request from the intended recipient(s) for the package 308. The request may be in the form of an HTTP request. For example, in one embodiment, the email notification to the recipient(s) includes a URL in the body of the message. When the recipient clicks the URL, a browser or browser-enabled application is opened and navigates to the site identified by the URL. The URL may include information necessary for the user to log into the package distribution server (104), or the recipient(s) may be required to provide authentication information.

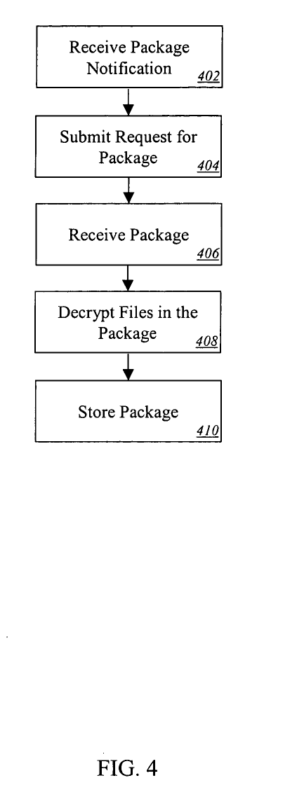

In response to the request for the package, the package distribution server (104) transmits the package to the requesting recipient 310. In one embodiment, the request and receipt of the package occurs under the control of a Java applet. Such an embodiment is described in relation to FIG. 4 below.

Once the package distribution server (104) has distributed a package to a recipient, the package distribution server (104) updates attributes of the package 312. For example, in one embodiment, a particular recipient may only download a package once. In such an embodiment, the package distribution server (104) updates the package attributes, indicating that the recipient has downloaded the package, and barring the recipient from subsequently downloading the same package.

In the embodiment shown in FIG. 3, the package distribution server (104) next causes a charge to occur in sender's account for the distribution of the package 314. For example, in one embodiment, the sender is charged five cents for each package that is successfully delivered to a recipient. The package distribution server (104) does not cause any charge to the sender's account until the package is delivered. In some embodiments, the costs for related senders or for related accounts are rolled up for higher-level reporting. For instance, if all of the employees in a company distribute files, the charges for the individual employees may be shown in a single, consolidated bill.

A package distribution server (104) may be configured to serve multiple organizations or multiple departments within a single organization. For example, in one embodiment, a package distribution server (104) is configured to serve two organizations. The administrator for the package distribution server enters attributes of each organization, including the administrator for each. The administrator for each organization is then able to specify the users who are able to function as senders for that organization. In such an embodiment, senders for one organization are only able to access the instance of their organization's package distribution server (104), and charges accrue to the organization only for their activity.

### Receiving a Package

FIG. 4 is a flowchart illustrating a method for receiving a package in one embodiment of this invention. In the embodiment shown, the recipient client device (110a) receives notification of a package available on the package distribution server (104) 402. As discussed above, the notification may be received in various forms.

The recipient views the notification and causes the recipient client device (110a) to submit a request to the package distribution server (104) for the package 404. The request may be, for example, an HTTP request directed to an address at which a Java applet is stored. The recipient may be required to submit a username and/or password for authentication purposes. In one embodiment, the username/password are provided as a part of the URL in the package notification. In other embodiments, hardware mechanisms are used to authenticate the user.

For example, in one embodiment, a smart card is embedded in a Universal Serial Bus (USB) drive (sometimes referred to as a keychain drive). The smart card includes information identifying a particular recipient. The package recipient application utilizes the authentication information in the smart card to authenticate the recipient and authorize the downloading of the package. In other embodiments, alternative forms of authentication may be used such as a smart car, USB token, smart credit card, or biometric identification in the form of a thumb/had print identification or retinal scan.

In the embodiment shown in FIG. 4, the recipient client device (10a) receives a package in response to the request 406. The recipient client device (110a) decrypts the files in the package 408. The files may be decrypted multiple times, the number of times corresponding the encryption process performed on the files. In one embodiment, the recipient provides the secret word for decryption. In another embodiment, encryption key information is stored on a smart card of a USB drive to enable decryption of the files. Once the files have been decrypted, the recipient client device (110a) causes them to be stored, e.g., on a hard drive 410.

In one embodiment of the present invention, which is also described in relation to the package distribution server (104) above, the notification is sent to the recipient in the form of an email with a URL. The URL identifies a destination on a web server running on the package distribution server (104). The recipient opens the email and clicks on the URL to submit a request to the package distribution server (104).

The recipient's request causes a Java applet to be downloaded to the recipient client device (110a). The Java applet requests the recipient's user name, password, and, if applicable, secret word. The recipient supplies this information, and the Java applet conveys the information to the package distribution server (104). If the information is valid, the package distribution server (104) transfers information to the Java applet for displaying the available package. The recipient is then able to select the package for downloading and decrypting. In one such embodiment, once the Java applet downloads the package, the Java applet decrypts the package. The decryption may include, for example, reversing a 3DES encryption performed during upload of the files and the package.

As described above, a feature of one embodiment of the present invention is that package transmission may be monitored and the delivery of a complete or incomplete package may be determined. If transmission of a package is interrupted, for example due to loss of a data connection, such that only partial contents of a package are transmitted, transmission of the package may be resumed with transmission of the remaining contents of the package. A variety of methods may be utilized to implement this feature. In one embodiment, as a package is prepared for sending or receiving, the server takes a “finger print” of each file in the package. This ensures that if the package has to be resumed, the server is certain that the resumed files in the package are exactly the same as the original files (even if the file names are the same). When sending and receiving a package, the package may be sent in blocks (configurable as to the size of these blocks). If transmission is lost or the transfer is stopped prematurely, the server logs the point at which this occurred. Therefore, when the transmission (sending or receiving) is resumed, the server first determines if the package being resumed is the same as the one before and then resumes the transmission at the nearest complete block to the stored pointer.

FIG. 5 is a screenshot of the first page of a package creation user interface in one embodiment of this invention. The user interface shown allows the user to specify various attributes of the package, including package label, the recipient(s) or mailing list, and a message.

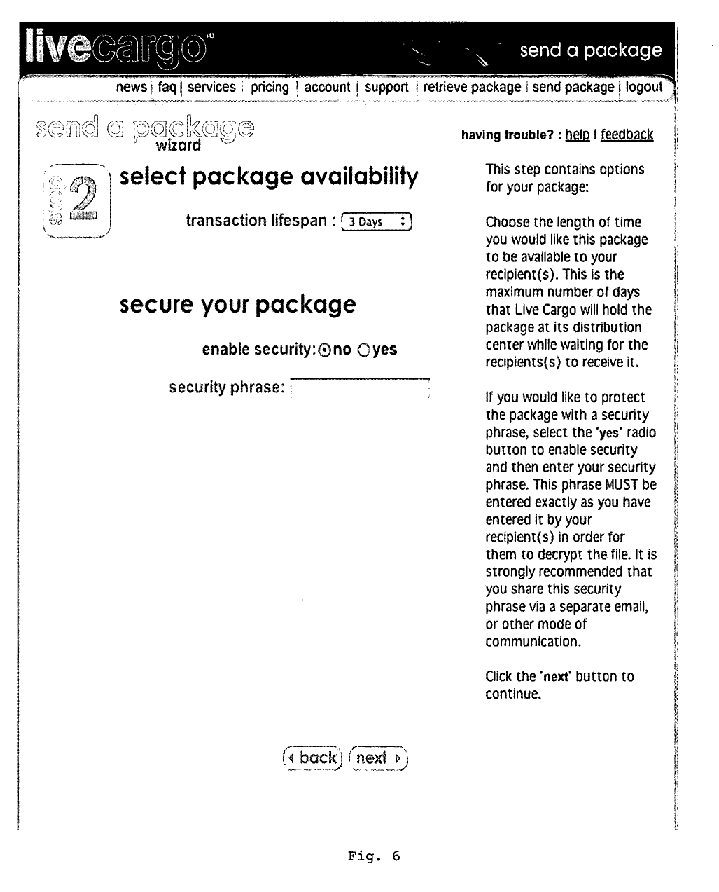

FIG. 6 is a screenshot of the second page of the package creation user interface shown in FIG. 5. The user interface shown allows the user to provide additional package attributes, including the package availability (3 days in the example) and a security phrase.

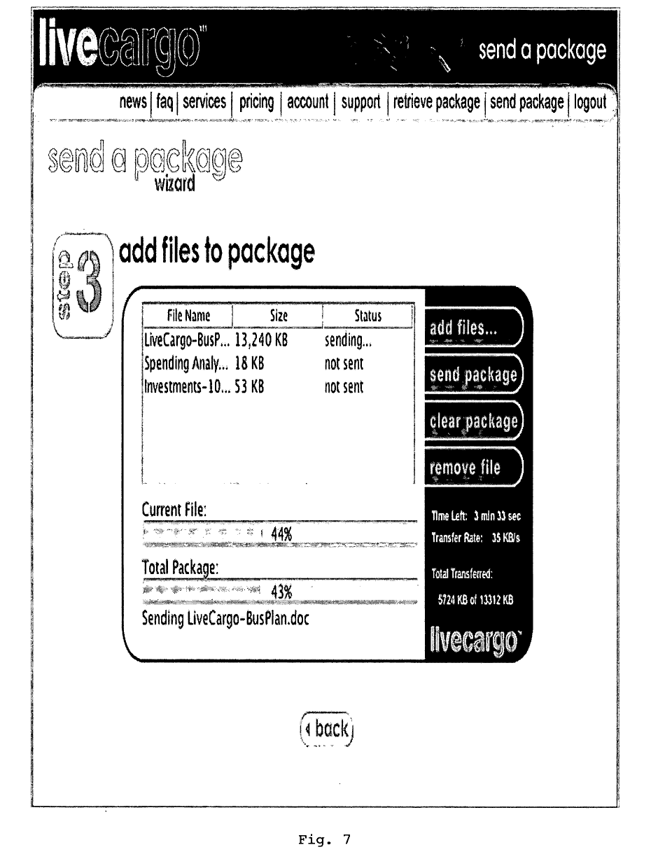

FIG. 7 is a screenshot of the third page of the package creation user interface shown in FIGS. 5 and 6. The user interface shown in FIG. 7 allows the user to add files to or remove files from the package, send the package, and clear the package. The interface also provides status to the user during file transfer, providing both package and file-level status information.

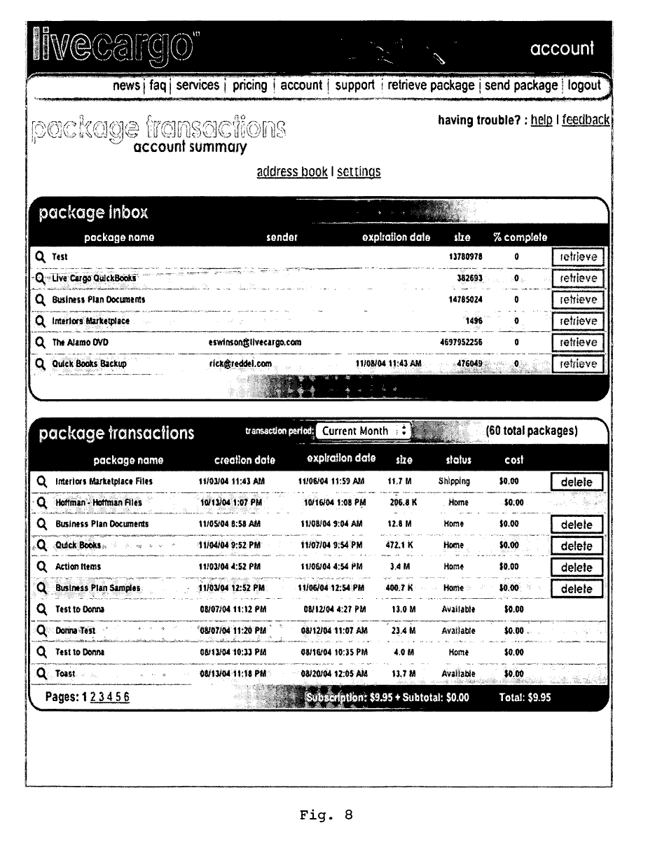

FIG. 8 is a screenshot of a user interface for managing incoming and outgoing packages in one embodiment of this invention. In the embodiment shown, the user is able to view packages available for download in the Package Inbox. The user can also view a history and current status of packages previously sent or received. The user is also presented with a cost of each of the packages sent as well as the subscription cost to the user.

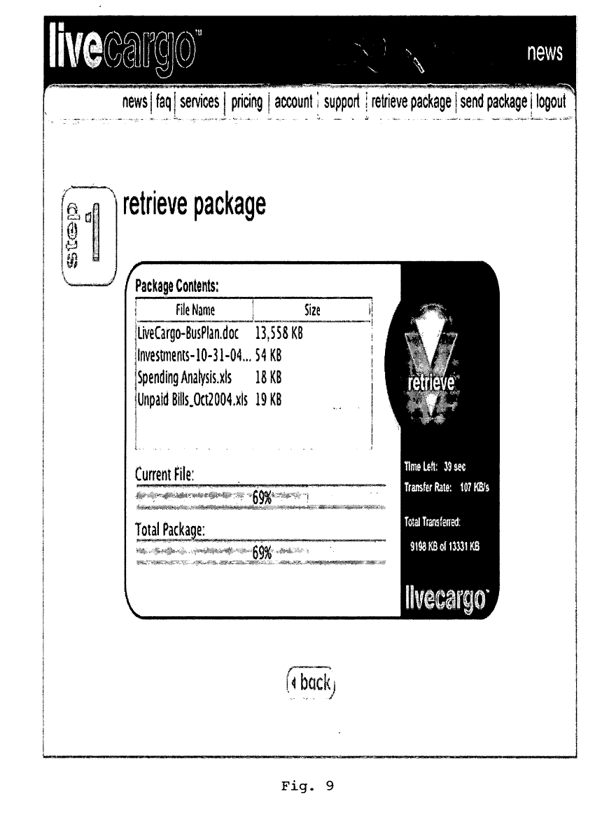

FIG. 9 is a screen shot of a user interface for receiving a package in one embodiment of this invention. In the embodiment shown, the user has previously selected a package to retrieve. The user interface displays the package contents (i.e., the files contained in the package), and attributes of the package contents, such as the size of each file contained in the package. The interface also provides status information to the user in various formats, including status bars indicating the percentage of the file and total package downloaded as well as the time left to complete the transfer, the transfer rate, and the total data transferred.

### EXAMPLE

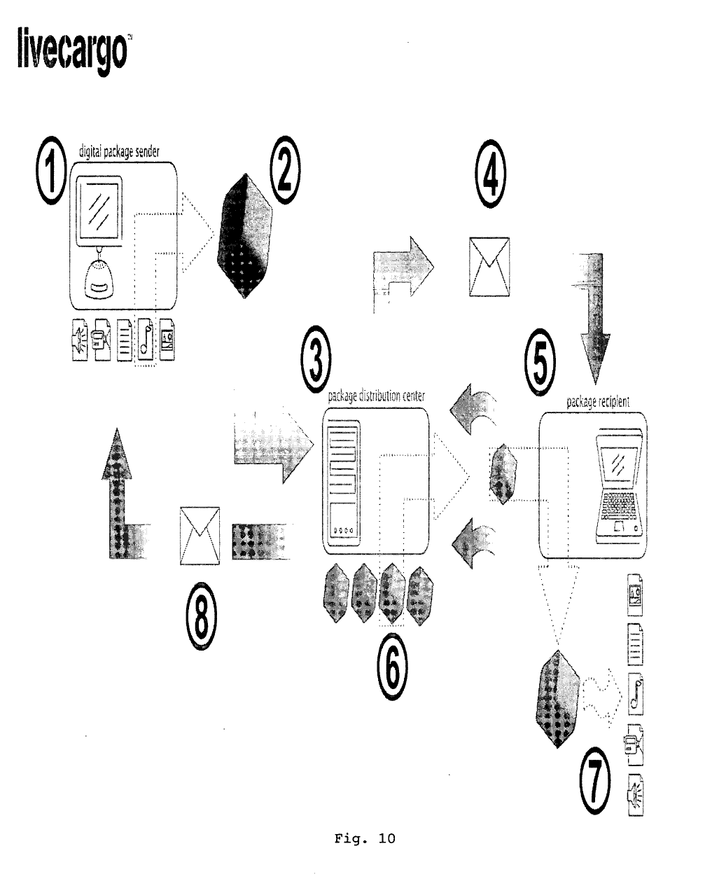

FIG. 10 is a block diagram illustrating the flow of electronic information in one embodiment of the present invention. The embodiment shown in and described in relation to FIG. 10 comprises a set of software components for a user to quickly, easily and reliably send electronic data securely from its origination point to defined destination(s) electronically through a storage/distribution center (Hub). This embodiment shown executes a two-part transaction.

In the embodiment shown, the Internet is being used as a network channel. The Internet is a vast collection of inter-connected networks that primarily use the TCP/IP protocol to communicate and a packet switched media to transmit messages. The inter-connected networks individually may consist of Ethernet network systems, Token Ring network systems or other network configurations.

The software components utilize the network to establish communication links. Each of these components may access the network channel in a variety of ways, such as a direct physical connection to the network channel; the physical connection refers to twisted wire pairs, coaxial cable or optical fibers as its physical media, which interconnects the component to a network channel. In addition, a component may access the network channel through a local area network (LAN). A LAN may support one or more components including a storage/distribution center (Hub).

Alternatively, a software component may access a network channel through an Internet service provider. The various configurations may apply to either the sending component, receiving component, or the Hub as discussed in relation to various embodiments of this invention. Those skilled in the art will appreciate that a variety of means can be used for accessing a variety of different network configurations.

When information is to be transferred using this system, the sending component negotiates and authenticates itself with the Hub as a valid sending unit. Upon approval from the Hub, the sending component encrypts the information using the 3DES encryption algorithm, and begins transferring the electronic information via the SSL encryption algorithm. The Hub then begins receiving the information in pieces or packets of electronic data. When the Hub receives the last bit of information, the first part of the transaction is logged as complete and a notification bit is enabled to signal the receiving component that there is information waiting for it at the Hub. If communication is lost or interrupted during the transmission of information to the Hub, the sending component and Hub can reinstate the information transfer from the point at which their connection was removed and repeat the sending process when communication is restored.

The Hub contains a unique key that ensures both the sending components and receiving components are communicating with a valid storage/distribution center (Hub). Likewise, the Hub ensures that the originating and destination points are valid. When the receiving component is ready to receive the information, it communicates with the Hub to establish connectivity and authentication. Once authenticated, the Hub begins sending information via the SSL encryption algorithm. When the last bit of information is received by the receiving component, the second part of the transaction is logged as complete and a notification bit is enabled to signal the Hub that the information was received. If communication is lost or interrupted during the transfer of information to the receiving component, the Hub and receiving component can reinstate the information transfer from the point at which their connection was removed and repeat the receiving process when communication is restored.

During this entire transaction process, the system maintains the integrity of the information to ensure it is complete, secure and delivered properly to the intended recipient(s). Upon verification that the information is successfully received, the electronic information is removed from its secure central storage location (Hub).

In addition to securing the information with 3DES encryption and SSL data transfer algorithms, there are four (4) additional levels of security available in this embodiment of the invention.

First, for every information transfer transaction, the information is stored in a unique location at the Hub and provided a unique “package key”. The package key is a unique 16-24 alphanumeric character string that is automatically generated and associated with the information being transferred. Also, every receiving component has its own unique ID. The receiving component must provide both its unique ID and package key in order to authenticate with the Hub and receive the information.

Second, each Hub component is compiled with a unique “seed” password. The sending and receiving components are matched with this encoded “seed” password and must include it as part of the encryption key to prevent information from being sent through the system from an unauthorized component.

Third, the sending component can also include a pass phrase prior to sending information to further secure the data being transferred. If this level of security is used, the pass phrase is provided to the receiving component via other communication channels (e.g., phone or email) in order to improve its security. The receiving component must include the correct pass phrase provided by the sending component for that particular information in order to properly decrypt the data and receive it.

And fourth, the Hub can also include a unique profile key for each receiving component. This profile key is stored in both the Hub's repository as well as a physical memory device that the receiving component holds. If this level of security is used, the receiving component can only receive the information from the Hub when the physical memory device is in the presence of the receiving component.

The Hub component acts as the supervisor and central repository of all transactions. It contains configuration parameters to establish the appropriate settings based on the particular use of the system; it distributes the sending and receiving components to authenticated users; and it houses the transaction log which contains the history of all information about the sending and receiving components for each individual transaction including IP Addresses, date, time, transfer size, package key, status bits, and other pertinent information related to the application.

The Hub is serialized with a unique “seed” password and the other components are matched to work together as a unit. This allows an unlimited number of similar and dissimilar implementations of embodiments of this invention without interference with one another.

The foregoing description of the embodiments of this invention has been presented only for the purpose of illustration and description and is not intended to be exhaustive or to limit the invention to the precise forms disclosed. Numerous modifications and adaptations thereof will be apparent to those skilled in the art without departing from the spirit and scope of this invention.

1. A method comprising:
receiving a package comprising at least one file from a sender;
storing the package;
notifying a recipient that the package has been stored;
receiving a request from the recipient for the package; and
transmitting the package to the recipient.

2. The method of claim 1, wherein the recipient comprises a first recipient and the request comprises a first request, and further comprising:
notifying a second recipient that the package has been stored;
receiving a second request from the second recipient for the package; and
transmitting the second package to the second recipient.

3. The method of claim 1, further comprising recording a transaction charge to an account associated with the sender.

4. The method of claim 1, wherein the at least one file comprises a plurality of files

5. The method of claim 1, wherein the package comprises an duration value and further comprising deleting the package at the expiration of the duration value.

6. A method comprising:
receiving a package attribute associated with a package;
receiving a file identifier associated with a file;
associating the file with the package;
encrypting the file;
receiving a recipient identifier associated with a recipient;
associating the recipient identifier with the package;
causing the package and the associated file to be transmitted to a package hub; and
causing a package notification to be sent to the recipient.

7. The method of claim 6, wherein encrypting the file comprises:
encrypting the file using a 3DES encryption;
encrypting the file using a pass code; and
encrypting the file using secure sockets layer (SSL).

8. The method of claim 6, further comprising:
receiving a package availability value; and
associating the package availability value with the package.

9. The method of claim 6, further comprising associating the package with an authentication value.

10. The method of claim 9, wherein the authentication value comprises a third-party authentication value (e.g., Electronic Postmark™).

11. The method of claim 6, further comprising:
receiving a smart card identifier; and
authenticating a user associated with the package based on information stored on the smart card.

12. The method of claim 6, wherein authenticating the user comprises comparing a first code on a smart card with a second code entered by the user.

13. The method of claim 6, wherein encrypting comprises encrypting with a code on a smart card.

14. A method comprising:
receiving notice that a package is available at a package hub, the package containing at least one file;
requesting the package from the package hub;
receiving the package from the package hub.

15. The method of claim 14, further comprising decrypting the at least one file.

16. The method of claim 14, further comprising causing the at least one file to be stored.

17. The method of claim 14, further comprising:
receiving a first checksum from the package hub; and
calculating a checksum on the at least one file.

18. A computer-readable medium on which is encoded program code, the program code comprising:
program code for receiving a package comprising at least one file from a sender;
program code for storing the package;
program code for notifying a recipient that the package has been stored;
program code for receiving a request from the recipient for the package; and
program code for transmitting the package to the recipient.

19. The computer-readable medium of claim 18, wherein the recipient comprises a first recipient and the request comprises a first request, and further comprising:
program code for notifying a second recipient that the package has been stored;
program code for receiving a second request from the second recipient for the package; and
program code for transmitting the second package to the second recipient.

20. The computer-readable medium of claim 18, further comprising program code for recording a transaction charge to an account associated with the sender.

21. The computer-readable medium of claim 18, further comprising program code for encrypting packages.

22. The computer-readable medium of claim 21, further comprising program code for comparing a check sum of encrypted packages.

23. The computer-readable medium of claim 21, further comprising program code for generating at least one unique key for an encrypted package.

24. The computer-readable medium of claim 18, further comprising program code for performing port shifting to negotiate transfer of packages.

25. The computer-readable medium of claim 18, wherein the package comprises a duration value and further comprising program code for deleting the package at the expiration of the duration value.

26. The computer-readable medium of claim 18, further comprising program code for determining the complete transfer of a package and program code for resuming transmission of a partially sent or received package.

27. A computer-readable medium on which is encoded program code, the program code comprising:
program code for receiving a package attribute associated with a package;
program code for receiving a file identifier associated with a file;
program code for associating the file with the package;
program code for encrypting the file;
program code for receiving a recipient identifier associated with a recipient;
program code for associating the recipient identifier with the package;
program code for causing the package and the associated file to be transmitted to a package hub; and
program code for causing a package notification to be sent to the recipient.

28. The computer-readable medium of claim 27, wherein program code for encrypting ether file comprises:
program code for encrypting the file using a 3DES encryption;
program code for encrypting the file using a pass code; and
program code for encrypting the file using secure sockets layer (SSL).

29. The computer-readable medium of claim 28, further comprising:
program code for generate a unique encryption key.

30. The computer-readable medium of claim 27, further comprising:
program code for receiving a package availability value; and
program code for associating the package availability value with the package.

31. The computer-readable medium of claim 27, further comprising program code for associating the package with an authentication value.

32. The computer-readable medium of claim 27, further comprising:
program code for receiving a smart card identifier; and
program code for authenticating a user associated with the package based on information stored on the smart card.

33. The computer-readable medium of claim 32, wherein program code for authenticating the user comprises program code for comparing a first code on a smart card with a second code entered by the user.

34. The computer-readable medium of claim 32, wherein program code for encrypting comprises program code for encrypting with a code on a smart card.

35. A computer-readable medium on which is encoded program code, the program code comprising:
program code for receiving notice that a package is available at a package hub, the package containing at least one file;
program code for requesting the package from the package hub;
program code for receiving the package from the package hub.

36. The computer-readable medium of claim 35, further comprising program code for decrypting the at least one file.

37. The computer-readable medium of claim 35, further comprising program code for causing the at least one file to be stored.

38. The computer-readable medium of claim 35, further comprising:
program code for receiving a first checksum from the package hub; and
program code for calculating a checksum on the at least one file.
